(19) United States
(12) Patent Application Publication
(10) Pub. No.: US 2016/0097415 A1
(43) Pub. Date: Apr. 7, 2016

(54) Combination Countertop Leveling and Connecting Device and Method

(71) Applicant: Kris Jorgensen, Mukilteo, WA (US)

(72) Inventor: Kris Jorgensen, Mukilteo, WA (US)

(21) Appl. No.: 14/877,831

(22) Filed: Oct. 7, 2015

Related U.S. Application Data
(60) Provisional application No. 62/061,095, filed on Oct. 7, 2014.

(51) Int. Cl. F16B 12/04; F16B 12/14

(52) U.S. Cl. CPC F16B 12/04; F16B 12/14

(57) ABSTRACT

A combination leveler and fastening device for mounting a countertop to a floor cabinet. The device includes a body with a longitudinally aligned bore, a continuous external threads formed on the outside surface of the body, two opposite ends perpendicularly aligned with the body's longitudinal axis and a plurality of radially slots formed on each end. The device is screwed into a hole formed in the cabinet's corner block, brackets or a sub-top. By rotating the device in the hole, the upper portion of the device that extends above the block, bracket or sub-top may be selectively adjusted to level the countertop when placed over the floor cabinet. Depending on the construction of the countertop, either a threaded connector with a narrow threaded shaft and wide head may be inserted into the device's bore which its tip embedded into the bottom surface of the countertop, or a compatible adhesive may be squeezed into the bore which flows and spreads laterally through the radial slots formed on the upper end of the device and into the space created between the bottom of the countertop and the top edge of the floor cabinet, the corner bracket, block or sub-top.

This utility patent application is based upon and claims the filing date benefit of U.S. provisional patent application (Application No. 62/061,095) filed on Oct. 7, 2014.

### COPYRIGHT NOTICE

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention

This invention pertains to devices used to level and connect a countertop to a floor cabinet, and more particular to such devices that allow a worker to simultaneously level and connect the countertop made of different materials to a floor cabinet.

2. Description of the Related Art

When installing a countertop on a floor cabinet, the countertop must be supported so it is horizontally level and does not wobble. To compensate for floors that are not level, wedges or shims are commonly inserted between the countertop and floor cabinet.

The countertop must be securely attached to the floor cabinet. The method used to attach a countertop to the floor cabinet depends on constructing the floor cabinet and the countertop's material. With solid wood or laminated countertops, L-shaped brackets and threaded fasteners that can be drilled into the countertop may be used.

With composite, solid surface or stone slab countertops, the countertop must be precisely aligned over the floor cabinet and then lifted to deposit a suitable amount of adhesive between the top edge of the floor cabinet and the bottom surface of the countertop. Adhesive applied to the top edge must be controlled to prevent drips.

Workers hired to install a countertop onto a floor cabinet must know ahead of time, the type countertop installed so they carry the adequate number of brackets and threaded connectors, and a sufficient amount of adhesive.

What is needed is a single device that can level and connect countertops made of different materials to a floor cabinet.

### SUMMARY OF THE INVENTION

The above stated need is addressed by a combination leveler and fastener device for quickly and easily mounting a countertop to a lower floor cabinet. The fastener device includes a cylindrical body with a continuous, longitudinally aligned bore formed, a continuous external thread formed on the body's outside surface, two opposite flat ends perpendicularly aligned with the body's longitudinal axis and a plurality of radially extending slots formed on each end. The device is screwed into a hole formed in the floor cabinet's sub-top or formed in corner blocks or brackets attached to the floor cabinets. By rotating the device in the hole, the installer may adjust the upper portion of the device that extends above the corner block, bracket or sub-top to level the countertop over the floor cabinet. If the countertop is made of material that can be used with threaded connectors, then a threaded connector with a narrow threaded shaft and wide head may be inserted into the device's bore and the tip of the threaded connector becomes embedded into the bottom surface of the countertop after it has been aligned over the floor cabinet.

If the countertop is made of material that must be attached to a floor cabinet with adhesive, the device is attached to a hole formed on the cabinet's sub-top, corner blocks or brackets. The threaded connector is replaced with a suitable adhesive squeezed directly into the device's bore which flows upward and eventually spreads laterally through the slots formed on the upper end of the device and into the space created between the bottom surface of the countertop and top surface of the sub-top, corner block or bracket.

Using the above described device, a system for leveling and connecting using threaded connectors or adhesive is disclosed with a method for easily leveling and connecting a countertop to a cabinet is disclosed.

### DESCRIPTION OF THE DRAWINGS

FIG. 1 is a perspective view of a countertop made of material that can be attached to a lower floor cabinet with threaded connectors showing a lower cabinet with corner blocks at opposite corners, and an intermediate block with combination leveler and fastener devices being inserted into holes formed in each corner block or intermediate block.

FIG. 2 is a perspective view of a countertop made of material that cannot be attached to a lower floor cabinet with threaded connectors being installed over a lower cabinet that includes a planar sub-top with holes formed in the sub-top in which combination leveler and fastener devices are inserted.

FIG. 3 is a partial side elevational view of a countertop shown in FIG. 1 installed over a lower floor cabinet with a corner block showing a combination leveler and fastener device attached to and extending above the top surface of the corner block and showing a threaded connector inserted into the bore formed on the device and connecting to the bottom surface of the countertop.

FIG. 4 is a partial side elevational view of the countertop shown in FIG. 2 being installed over a lower floor cabinet with a sub-top attached to the top of the floor cabinet and showing a combination leveler and fastener device attached to and extending above the top surface of the sub-top which creates a space between the sub-top and countertop filled with a suitable adhesive.

FIG. 5 is a front perspective view of the combination leveler and fastener device.

FIG. 6 is a side elevational view of the combination leveler and fastener device shown in FIG. 5.

FIG. 7 is a top plan view of the combination leveler and fastener device shown in FIGS. 5 and 6.

### DESCRIPTION OF THE PREFERRED EMBODIMENT(S)

Disclosed herein is a combination leveler and fastener device 10 for quickly and easily mounting a countertop 40, 40′ made of different materials to the top edge 81 of a floor cabinet 80 or the top surface of a sub-top 86 disposed over the floor cabinet 80. The device 10 is designed to be used with countertops 40 made of various materials compatible with threaded connectors 50 such as wood or wood based materials, or made of materials not compatible with threaded connectors 50 but compatible with an adhesive 60, such as stone, concrete, quartz, etc.

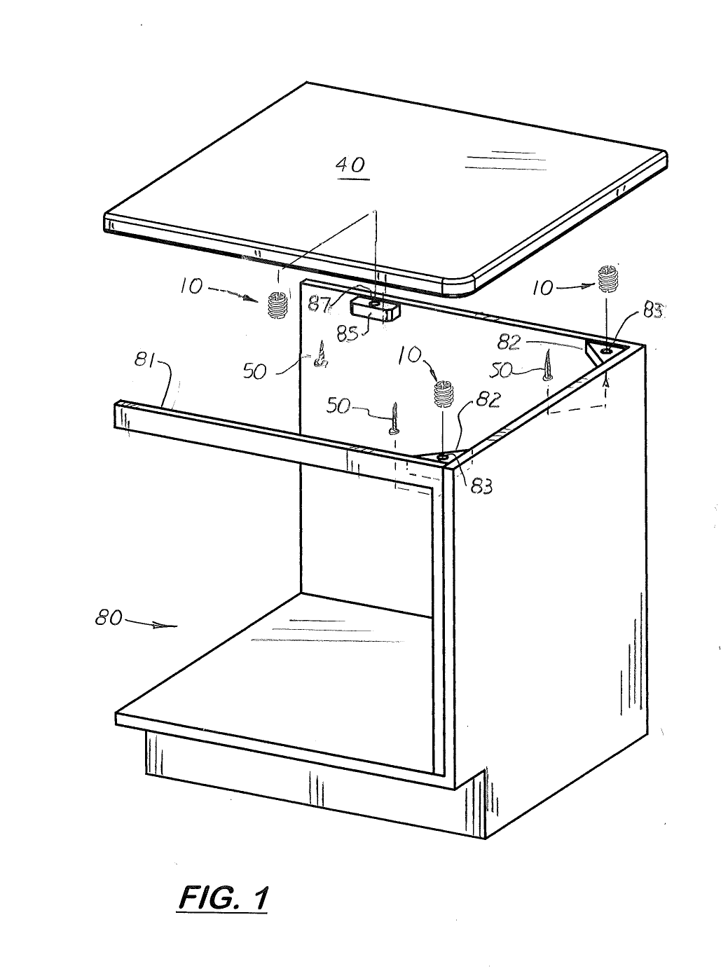

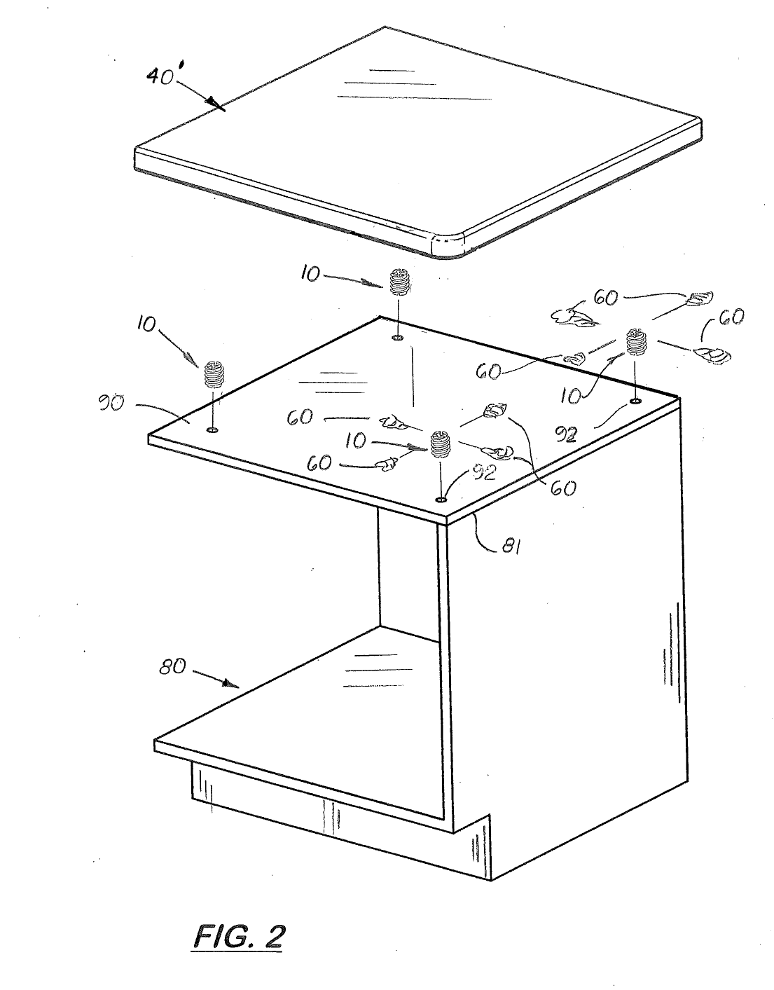

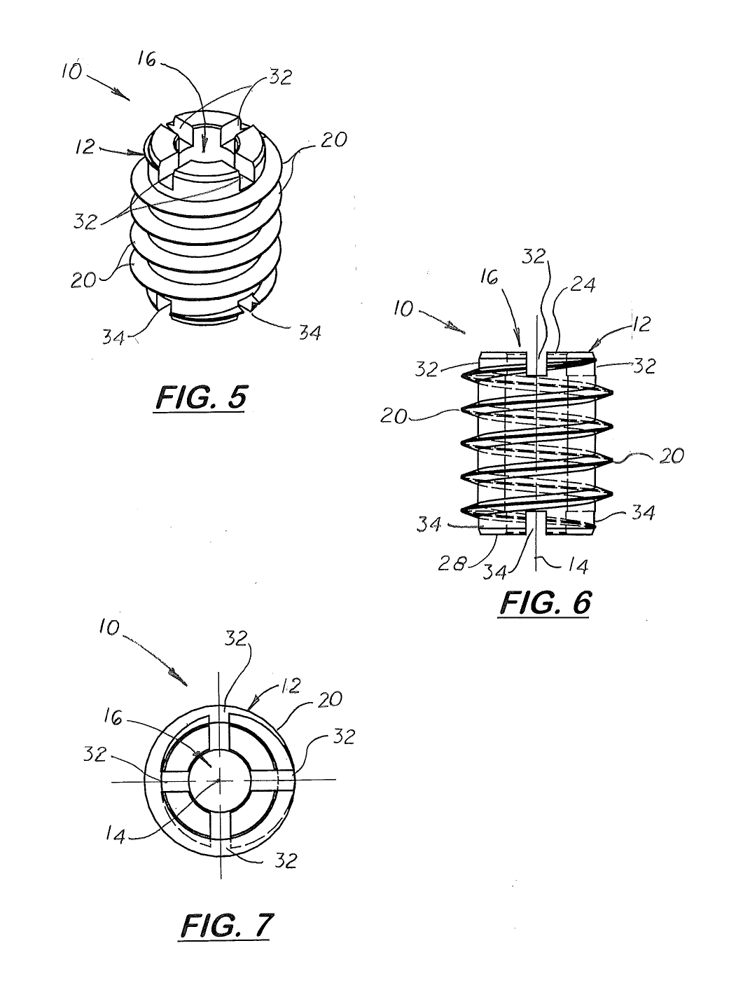

As shown in FIGS. 5-7, the fastener device 10 includes a body 12 with a continuous, longitudinally aligned bore 16, the continuous external threads 20 formed therein, two opposite flat ends 24, 28 perpendicularly aligned with the body's longitudinal axis 14 and a plurality of radially aligned slots 32, 34 formed in each end, 24, and 28, respectively. The device 10 is designed to be embedded or attached to continuous hole 84 formed on a corner block 82 or intermediate block 83 located near the top edge 81 of a floor cabinet 80 as shown in FIG. 1, or embedded or attached to a continuous hole 88 formed on a planar sub-top 86 attached over the top edge 81 of a floor cabinet 80 as shown in FIG. 2. In the embodiment shown herein, there are four slots 32, 34 in an ‘X’ configuration formed on each end 24, 28, respectively. The dimensions of the body 12 and the width of the slots 32, 34 are sufficient to enable a worker to manually screw the device 10 into the holes 84 or 88 using a bladed tool. In the embodiment shown herein, the holes 84, 88 may have straight walls that are slightly smaller in diameter than the external threads 20 and larger than the body 12 which enables the threads 20 to self-tap and translate when rotated inside the holes 84, 88. It should be understood, however, that the holes 84, 88 may include internal threads (not shown) that connect directly to external threads 20 on the body 12. In the embodiment shown herein, the body 12 is cylindrical. It should be understood that the body 12 may be other shapes—planar, square, circular, conical, etc.

Because the corner blocks 82, intermediate block 83, and sub-top 86 are at or near the top edge 81 of the floor cabinet 80 and under the countertop 40, 40′ respectively, by manually rotating the device 10 in the hole 84, 88, respectively, the height of the upper end 24 of the body 12 may be flush or even with the top surface 83 or 87 of the corner blocks 82, intermediate block 83, or sub-top 86, respectively, or it may extend above the top surface of the corner blocks 82, brackets 83 or sub-top 86, respectively. By rotating the device 10 in the hole 84, 88, the worker may easily raise or lower the countertop 40, 40′ over the floor cabinet 80.

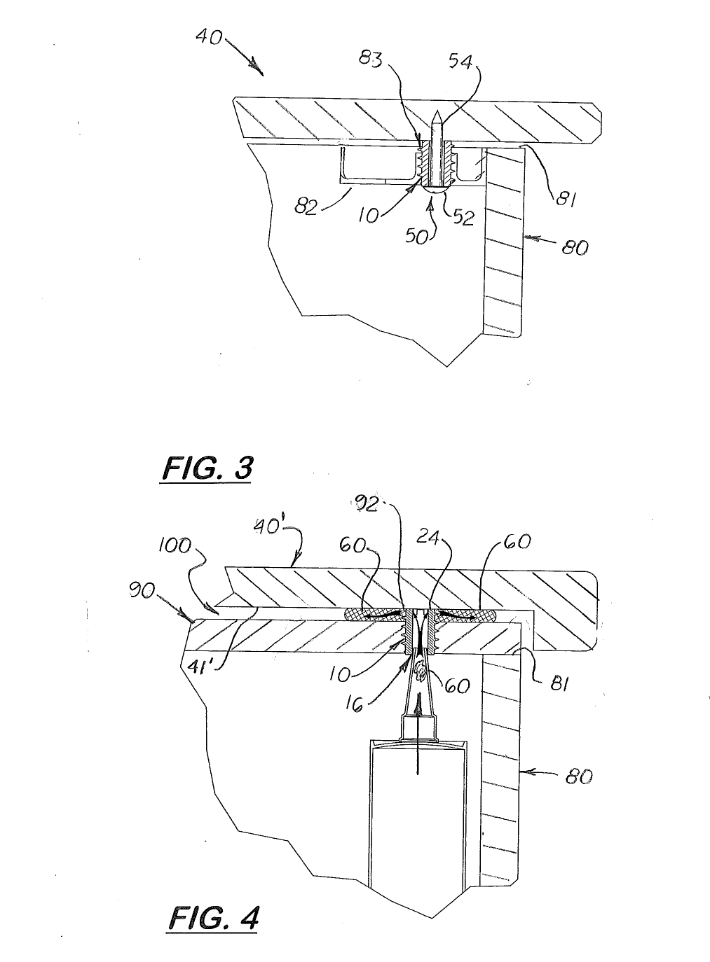

The first countertop 40 is made of wood or material compatible with threaded connectors 50 includes a wide head 52 attached to a threaded shaft 54. The wide head 52 is slightly larger in diameter than the bore 16 and presses against the lower end 28 of the body 12 during installation. The narrow shaft 54 extends through the bore 16 and the tip of the shaft 54 becomes embedded into the bottom surface of the countertop 40 as shown in FIG. 3. The threaded connector 50 is tightened to hold the countertop 40 on the floor cabinet 80.

The second countertop 40′ is made of material that cannot be used with a threaded connector 50. Instead, a suitable adhesive 60 must be deposited into the bore 16 that eventually flows through the slots 32 formed on the device's upper end 24. If the upper end 24 of the body 12 is elevated above the sub top 86, the adhesive 60 will flow through the slots 32 and fills the space 100 between the top surface 87 of the sub-top 86 and the bottom surface 41′ of the countertop 40′.

The body 12 may be made of wood, plastic, nylon, glass or metal, or a combination thereof The body 12 measures between ½ to 1½ inches in length, and ⅝ to 1¼ inches in width. The bore 16 measures between 3/16 to ½ inches in diameter. The slots 32, 34 measure approximately 3/16 inches in width. In the embodiments shown in the FIGS., the body 12 measures approximately ⅞ inches in length, ⅝ inches in diameter and the bore 16 measures approximately ¼ inches in diameter.

Using the above device 10, a system 100 for leveling and connecting a countertop made of different materials using either threaded connectors 50 or a suitable adhesive 60 is disclosed. Also disclosed is a method for easily leveling and connecting a countertop made of different materials to a floor cabinet 80 is disclosed that uses the system 100.

The method comprises the following steps;

a. selecting a countertop 40 made of material compatible with threaded connectors 50 or a countertop 40′ made of material not compatible with threaded connectors 50;

b. selecting a floor cabinet 80 to support said countertop 40, 40′, said floor cabinet 80 includes either corner blocks 82, intermediate blocks 84 or a sub-top 86, said corner block 82, intermediate block 84 or sub-top 86 includes holes 84, 88 and 92, respectively;

d. inserting into said hole 84, 88, or 92, a fastener device 10 that includes a body 12 configured to be inserted into said holes 84, 88, or 92, said body includes a continuous, longitudinally aligned bore 16, external threads 20, two opposite ends 24, 28 perpendicularly aligned with the body's longitudinal axis 14 and a plurality of radially aligned slots 32, 34 formed on each end, 24, 28, respectively;

e. rotating the body 12 inside said hole 84, 88, or 92 to adjust the desired distance said end of said body 12 extends above said corner block, said intermediate block 84 and said sub-top 86 to level said countertop over said floor cabinet; and,

f. inserted a threaded connector 50 into said bore 16 and tightening said threaded connector 50 into said countertop 40 or dispensing a suitable adhesive 60 into said bore 16 which flows through said slots 32 and against the bottom surface of said countertop 40′.

In compliance with the statute, the invention described has been described in language more or less specific as to structural features. It should be understood, however, that the invention is not limited to the specific features shown, since the means and construction shown comprises the preferred embodiments for putting the invention into effect. The invention is therefore claimed in its forms or modifications within the legitimate and valid scope of the amended claims, appropriately interpreted under the doctrine of equivalents.

I claim:

1. A combination leveler and fastener device for mounting a countertop to a floor cabinet, comprising;
a body with longitudinal axis, a center bore that extends along said longitudinal axis, external threads, and two opposite flat ends perpendicularly aligned with said longitudinal axis, each said opposite end includes at least two radially aligned slots that communicate with said center bore configured to receive a slotted tool used to rotate said body in a hole, said slots also configured to allow an adhesive deposited into said bore to flow outward through said slots.

2. The device, as recited in claim 1, further including a threaded connector with a wide head and a narrow threaded shaft, said wide head being larger in diameter than said bore.

3. The device, as recited in claim 1, wherein said body is made of wood, plastic, nylon, glass or metal.

4. The device, as recited in claim 1, further including a dispenser containing an adhesive that when dispensed in sufficient volume into said hole said adhesive flows into said slots and spreads laterally from body into a gap formed between a countertop and a top edge of said floor cabinet.

5. A system for leveling and fastening a countertop made of wood or rigid material not compatible with a threaded connector to a floor cabinet, comprising;
a. a floor cabinet with a horizontal mounting surface, said horizontal mounting surface includes at least one vertically aligned bore;
b. a countertop made of wood or rigid material incompatible with use of a threaded connector, said countertop configured to be installed over said mounting surface of said floor cabinet;
c. a combination leveler and fastener device that includes a body with a longitudinal axis, a center bore that extends along said longitudinal axis, external threads, and two opposite flat ends perpendicularly aligned with said longitudinal axis, each said end includes a plurality of radially aligned slots configured to receive a bladed tool used to rotated said body in said bore formed on said cab, said slots communicate with said center bore, said device threading connected to said bore formed on said floor cabinet, and adjusted therein so that one said end extends above said mounting surface a desired distance thereby supporting said countertop at a desired elevation above said mounting surface; and,
d. selecting a threaded connector with a wide head and threaded shaft configured to fit into said bore and connect said device to said countertop made of word or selecting a suitable adhesive configured to flow into said bore and against said countertop when said countertop is made of material incompatible with said threaded connector and compatible with said adhesively to adhesively attach said countertop to mounting surface.

6. A method for easily leveling and connecting a countertop made of different materials to a floor cabinet, comprising the following steps:
a. selecting a countertop made of material compatible with threaded connectors or a countertop made of material not compatible with threaded connectors;
b. selecting a floor cabinet to support said countertop, said floor cabinet includes side blocks, corner blocks, brackets or a sub-top;
c. forming a hole in a corner blocks, brackets or on the sub-top attached to a floor cabinet;
d. inserting into said hole a fastener device that includes a body with a continuous, longitudinally aligned bore, continuous external threads, two opposite ends perpendicularly aligned with the body's longitudinal axis and a plurality of radially aligned slots formed on each end;
e. adjusting the height of said device in said hole until one of said device is even with or extends above said corner block, said bracket or said sub-top; and,
f. when said countertop is made of wood a threaded connector is selected and inserted a threaded connector into said bore, said threaded connector includes a wide head and a shaft configured to be inserted into said bore and tightened to hold said device in said hole formed on said corner blocks, said brackets, or said sub-top, or when said countertop is made of material incompatible with said threaded connector, selecting a suitable adhesive and dispensing a sufficient quantity of said adhesive into said bore until said adhesive flows through said slots and against said countertop.
